(19) United States
(12) Patent Application Publication
(10) Pub. No.: US 2021/0387268 A1
(43) Pub. Date: Dec. 16, 2021

(54) DRILL STOP COLLET FOR USE WITH A HAND-HELD DRILL FOR WINDSHIELD REPAIR

(71) Applicant: Sandra Arlene Fenton, Monument, CO (US)

(72) Inventor: Sandra Arlene Fenton, Monument, CO (US)

(21) Appl. No.: 16/900,515

(22) Filed: Jun. 12, 2020

(51) Int. Cl. B23B 49/00

(52) U.S. Cl. CPC B23B 49/005

(57) ABSTRACT

An apparatus for securely holding a drill bit in a handheld drill, the drill bit including a pointed end and a bottom end, is described. The apparatus includes a collet, which includes a silo for accommodating the drill bit therein. The silo includes a fixed stop, such that the bottom end of the drill bit rests against the fixed stop, and a compressible collar for securing the drill bit within the silo. The drill bit has a drill bit length and the silo has a silo depth shorter than the drill bit length such that, when the drill bit is inserted into the apparatus, the pointed end of the drill bit protrudes from the apparatus by a maximum depth defined by the drill bit length minus the silo depth. The apparatus, when used with the handheld drill, only allows drilling of holes having a depth up to the maximum depth.

### FIELD OF THE INVENTION

The present invention relates to drilling tools and, more particularly, to drilling tools used in drilling to a precise depth.

### BACKGROUND OF THE INVENTION

From time to time, a vehicle windshield will break, typically due to an object impacting the windshield. Such breaks are typically approximately round breaks called chips, linear breaks called cracks, or some combination thereof. Windshields generally include an outer and inner layers of safety glass of standard thickness, separated by a plastic layer therebetween. Repairable windshield breaks are typically contained within the outer layer of safety glass, while the inside layer of safety glass remains unbroken. If the inner layer of safety glass is compromised, the windshield typically cannot be repaired, and would need to be replaced.

In the current state of windshield repair, a technician typically uses a hand-held drilling tool, such as a DREMEL® tool, fitted with a standard type collet and drill bit, to drill one or more holes into the outer layer of safety glass at various locations, depending on the type of break. Drilling is typically the first step in windshield repair, followed by various additional steps which may include tapping the drilled hole and the injection and curing of resin.

Control over the exact depth of drilling is reliant on the training and skill of the technician performing the windshield repair. Achieving a precise depth of the drilled hole ensures that only the outer layer of safety glass is penetrated while avoiding compromising the plastic layer between the outer and inner layers of safety glass. Achieving a precise penetration depth with the drill is a key aspect of successful windshield repair. However, not being able to gauge how far to drill into the safety glass is a frequent complaint of new professional and novice windshield repair technicians. Failure to drill to the correct depth may lead to further damage to the windshield, resulting in the need for a full windshield replacement, which can be costly and environmentally wasteful.

The drill bit used in windshield repair is typically fixed in a drilling tool using a chuck and collet that have been in use for many years, such as those described in U.S. Pat. Nos. 2,459,899 and 2,466,1129. The drilling assembly described in these patents can be used for a variety of purposes. For example, they allow a drill bit to be placed into the chuck and collet to variable depths. However, the person operating the assembly is responsible for controlling the depth drilled by applying manual pressure and then stopping when the desired depth is reached. There are a variety of tools for measuring the depth of a drilled hole after stopping and removing the drill bit. Yet, there is currently a lack of mechanisms for indicating when a specified depth has been reached while drilling into a laminated windshield safety glass. Consequently, it is possible to not drill far enough, requiring multiple tries to get to the correct depth. Or, in a worse case, it is possible to drill too far, such as into or beyond the plastic layer between the outer and inner layers of safety glass, making repair impossible and necessitating costly replacement of the entire windshield.

There are a number of technologies for managing the depth during drilling in various other specific applications such as woodworking (see, for example, U.S. Pat. No. 5,078,552) and surgical bone drilling (see, for example, U.S. Pat. No. 7,163,542). However, none of these technologies is practical for windshield repair application because they are very specific to the unique drill assemblies adapted for those particular applications.

In addition, there are a number of patents related to windshield repair methods, tools, and materials (see, for example, U.S. Pat. Nos. 7,125,507, 8,378,315, and 8,092,203). However, these patents do not specifically describe a solution for the typical starting point of the repair method, namely having to drill into the outer layer of safety glass to a precise depth, without penetrating into or through the plastic layer and the inner layer of safety glass.

### SUMMARY OF THE INVENTION

An apparatus for securely holding a drill bit in a handheld drill, the drill bit including a pointed end and a bottom end, is described. The apparatus includes a collet, which includes a silo for accommodating the drill bit therein. The silo includes a fixed stop, such that the bottom end of the drill bit rests against the fixed stop, and a compressible collar for securing the drill bit within the silo. The drill bit has a drill bit length and the silo has a silo depth shorter than the drill bit length such that, when the drill bit is inserted into the apparatus, the pointed end of the drill bit protrudes from the apparatus by a maximum depth defined by the drill bit length minus the silo depth. The apparatus, when used with the handheld drill, only allows drilling of holes having a depth up to the maximum depth.

In another embodiment, an apparatus for securely holding a drill bit for use with a handheld drill is described. The drill bit includes a pointed end and a bottom end. The apparatus includes a collet, which in turn includes a silo for accommodating the drill bit therein, and a compressible collar for securing the drill bit within the silo when the apparatus is inserted into the handheld drill. The compressible collar has a collar diameter. The apparatus further includes a drill guide having a drill guide diameter less than the collar diameter such that, when the drill bit is inserted into the apparatus, a user is able to measure a protrusion distance by which the drill bit protrudes from the drill guide. Further, the apparatus, when used with the handheld drill, only allows drilling of holes having a depth up to the protrusion distance.

### BRIEF DESCRIPTION OF THE DRAWINGS

FIG. 1 is an enlarged, isometric view of a drill bit inserted into a prior art collet/nut assembly, which is in turn inserted into a conventional drilling tool.

FIG. 2 illustrates an enlarged, isometric view of a first embodiment of a drill stop collet with a drill bit housed therein, in accordance with an embodiment, which is in turn inserted into a conventional drilling tool.

FIG. 3 is an isometric view of a conventional drilling tool including the drill stop collet assembly shown in FIG. 2, in accordance with an embodiment.

FIG. 4 is an isometric view of the drill stop collet of FIG. 2, shown here to illustrate further details of the drill stop collet, in accordance with an embodiment.

FIG. 5 is a cross-sectional view the drill stop collet of FIG. 2, shown here to illustrate further details inside of the drill stop collet, in accordance with an embodiment.

FIG. 6 is a cross-sectional view of a modified drill stop collet, in accordance with an embodiment.

FIG. 7 is a cross sectional view of an alternative drill stop collet, in accordance with an embodiment.

### DETAILED DESCRIPTION OF EMBODIMENTS OF THE INVENTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items, and may be abbreviated as “/”

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present. Likewise, when light is received or provided “from” one element, it can be received or provided directly from that element or from an intervening element. On the other hand, when light is received or provided “directly from” one element, there are no intervening elements present.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

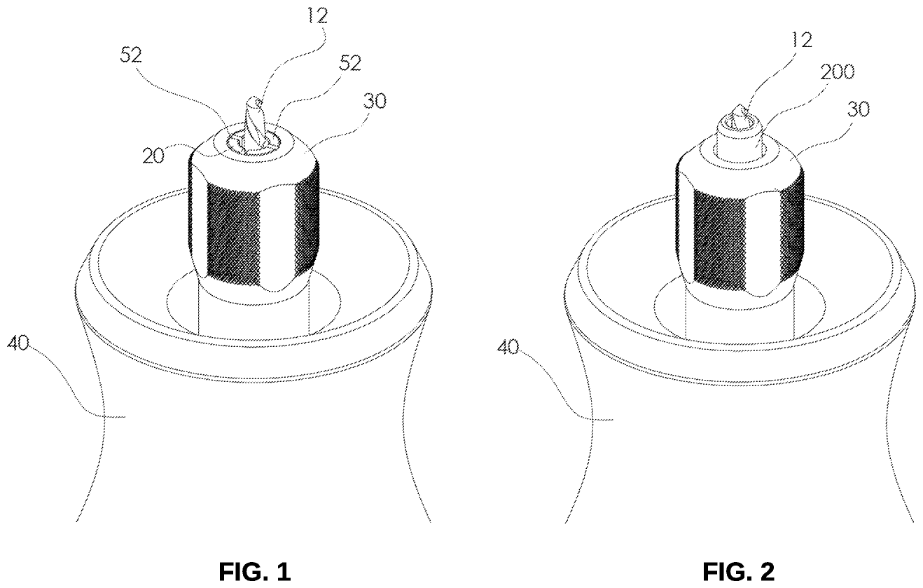

Referring to FIG. 1, an enlarged, isometric view of a drill bit 12 inserted into a prior art combination of a collet 20 and a nut 30, which is in turn inserted into a conventional drilling tool 40, is shown. While only a top surface of collet 20 is visible in FIG. 1, collet 20 is generally an elongated apparatus configured for accommodating drill bit 12 therein. In an example, collet 20 includes a plurality of kerf cuts 52, which are slit-like openings along at least a partial length of collet 20 such that, when nut 30 is overlaid and tightened around collet 20, the top of collet 20 is compressed around drill bit 12 to center and hold the drill bit within the collet.

Continuing to refer to FIG. 1, generally, the drill bit can be inserted into the collet such that the length of drill bit protruding from the collet is adjustable by the user. If a user decides to drill a hole of a desired depth, the user can manually measure the length of the drill bit protruding from the collet and nut combination is equal to the desired depth. Alternatively, the user can install a drill stop collar around the drill bit such that the length of the drill bit protruding from the drill stop collar corresponds to the desired depth. However, for small gauge drill bits, such as those used in windshield repair, the installation of a drill stop collar is impractical. Also, drill stop collars are prone to slippage and human error in achieving precise installation. A fool-proof way to install the drill bit in order to be able to drill holes of precise depths, particularly for windshield repair applications, would be desirable.

In contrast, the described embodiments in FIGS. 2-7 relate to a drill stop collet apparatus for use with a conventional handheld drill for drilling holes of a very specific depth, such as in drilling into the outer layer of a standard laminated windshield safety glass to a consistently precise depth for the purpose of repairing breaks in windshields. The apparatus described can also be used with a handheld drill or another similar tool for drilling to a consistently precise depth in other applications, such as woodworking, manufacturing, and other activities requiring precision drilling.

More specifically, the apparatus includes a modified collet having an internal silo with a physical stopping point. The internal silo surrounds a drill bit inserted into the collet and ensures that the bottom (i.e., non-pointed end) of the drill bit stops at a precise depth. In this way, rather than allowing the drill bit to be inserted into the collet to a variety of depths, or having to precisely install a drill stop collar, the modified collet allows the user to insert the drill bit to a specific depth, consistently and repeatedly. Simply, the drill bit is fully inserted into the modified collet until it cannot be pushed in any further. Since the modified collet is designed to accommodate a standard length drill bit, the length of the drill bit protruding from the collet is then precisely known, and holes of the desired depth can be accurately drilled by drilling to the point where the modified collet stops the drill bit from drilling any deeper. The physical stopping point provides the user with tactile feedback when the drill bit has been inserted into the internal silo to the specifically selected depth. The apparatus optionally includes a visual aid that is wider than the drill bit but narrower than the collar or gripping mechanism, and holds the apparatus and drill bit assembly firmly when installed in a drill. The visual aid thus helps the user visually gauge the angle and depth to which the drill bit is inserted into the material being drilled.

In other words, a standard drill bit installed in the modified collet extends a precise length from the point of the drill bit to the top of the collet. Different length drill bits and different length internal silos will provide different, yet equally precise, maximum drilling depths for that particular collet/bit assembly, in accordance with the embodiments described herein. A maximum drilling depth for a modified collet is defined as the length of the drill bit minus the length of the internal silo, as will be described in detail hereinafter.

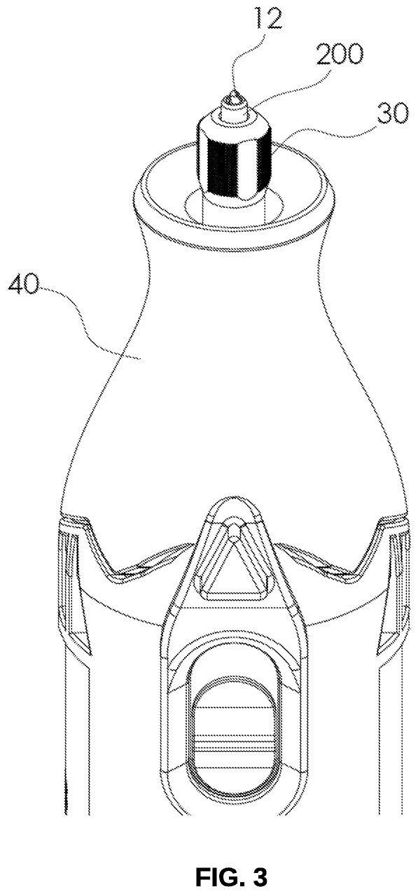

Referring now to FIG. 2, a drill stop collet 200, for use in windshield repair and other applications is described. As shown in FIG. 2, drill stop collet 200 protrudes slightly from nut 30, and drill bit 12 protrudes slightly from drill stop collet 200, in accordance with an embodiment. The amount the drill bit protrudes from drill stop collet 200 is the maximum drilling depth, as earlier described. As a reference, the components of FIG. 2 are shown in FIG. 3 in relation to conventional handheld drilling tool 40, in accordance with an embodiment. As can be seen, drill bit 12 is quite small compared to the rest of the drilling tool (note: the figure is not drawn to scale).

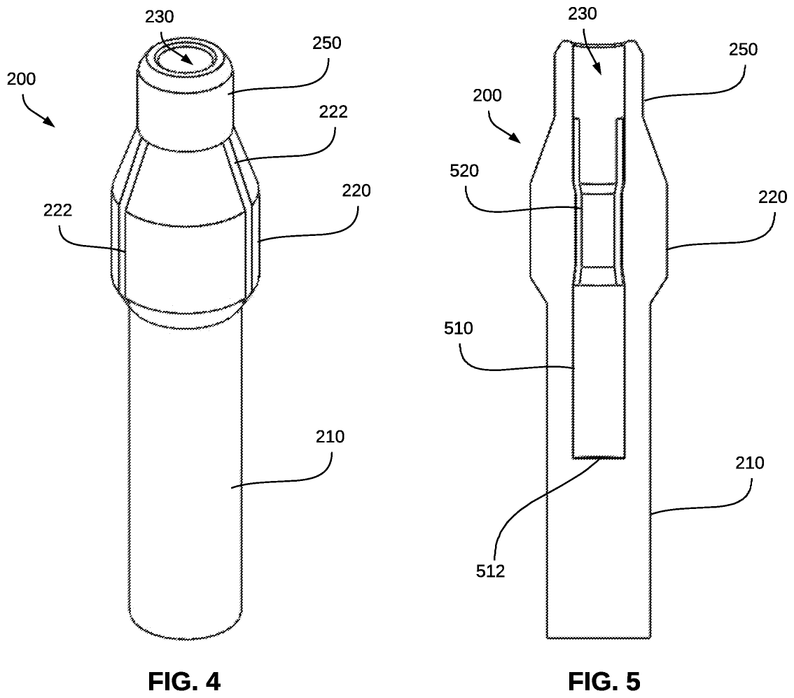

FIG. 4 shows further details of drill stop collet 200, in accordance with an embodiment. As shown in FIG. 4, drill stop collet 200 includes a base 210 and a collar 220. Collar 220 optionally includes a plurality of kerf cuts 222 such that, when a drill bit is inserted into an opening 230 and a nut (such as nut 30) is tightened around collar 220, the drill bit is securely held within opening 230. Alternatively, drill stop collet 200 includes another collar gripping mechanism such as, for example, forming collar 220 of a material having natural flexibility that allows compression around the drill bit when collet 200 is installed in a hand drill. Optionally, a guide section 250 proximate to collar 220 is configured for protruding above nut 30 (as shown in FIG. 2) so as to serve as a visual guide for a user aligning the drill bit to a specific location (e.g., a crack in an automobile windshield).

FIG. 5 shows a cross-sectional view of drill stop collet 200, in accordance with an embodiment. As shown in FIG. 5, drill stop collet 200 includes an internal silo 510, with a precise stopping point 512 defined at a bottom of internal silo 510. Internal silo 510 is designed to receive a drill bit 12 therein such that a pointed end of the drill bit extends beyond the top of drill stop collet 200 by the desired maximum depth. In other words, the depth of internal silo 510 is precisely set with respect to a standard drill bit length such that the length of the standard drill bit minus the depth of the internal silo provides the desired maximum depth.

Different combinations of drill bits of various standard drill lengths combined with internal silo formed to silo depths allows the user to select the desired maximum depth of a drilled hole needed for a particular task, such as windshield repair. That is, the exact depth of a drilled hole will be no greater than the maximum depth, defined as drill length minus the silo depth. For example, laminated glass windshields are standardized for the automotive industry, and drill bits are also standardized with precise drill lengths. Therefore, the necessary silo depth required to achieve the appropriate hole depth for windshield repair can also be standardized. Consequently, a windshield repair technician will typically need only one type of drill stop collet apparatus for windshield repair use, thus streamlining the repair process while at the same time reducing the possibility of error, such as drilling too far into the windshield safety glass.

In an embodiment, precise fixed stopping point 512 is provided as an indentation, a platform, a bar, or other means to serve as the physical stopping point for drill bit inserted into the internal silo.

Optionally, internal silo 510 includes an internal sleeve 520 to further cushion a drill bit inserted therein as the collar is tightened around the drill bit. The internal silo can have a cross-sectional shape such as a circle, triangle, square, pentagon, hexagon, and others, as long as stopping point 512 is precisely defined opposite opening 230 and a drill bit can be accommodated therein.

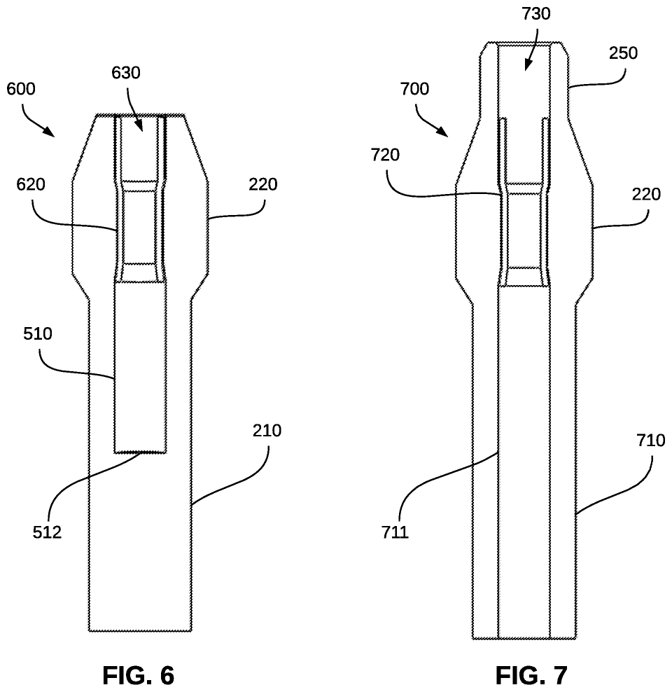

An alternative embodiment without a drill guide is shown in FIG. 6. A modified drill stop collet 600 includes base 210 and collar 220 similarly to drill stop collet 200 shown in FIGS. 2-5. However, modified drill stop collet 600 does not include a guide section proximate to collar 220. As shown in FIG. 6, modified drill stop collet 600 includes base 210 and collar 220, as in the embodiment shown in FIG. 4. Also, like drill stop collet 200 illustrated in FIGS. 2-5, modified drill stop collet 600 includes internal silo 510 and stopping point 512. In contrast to the embodiment shown in FIG. 4, modified drill stop collet 600 does not include a drill guide, and contains an internal sleeve 620 and an opening 630. Internal sleeve 620 and opening 630 can be identical to internal sleeve 520 and opening 230, respectively, of drill stop collet 200, or include modifications to accommodate the lack of a drill guide.

In an alternative embodiment, a drill collet with a drill guide and without a stop is illustrated in FIG. 7. Like drill stop collet 200 illustrated in FIGS. 2-5, a modified drill collet 700 includes base 210, collar 220, and guide 250. However, modified drill collet 700 has a base 710 with an internal silo 711, which is open all the way through drill collet 700 and without a stop. Due to the presence of guide 250, a user is able to use, for example, a gauge or calipers to measure the distance by which a drill bit inserted into an opening 730 of modified drill collet 700 protrudes from guide 250. In this way, the user is able to accurately measure the protrusion distance of a drill bit from guide 250, thus enabling the user to adjust the drill bit such that a hole of a desired depth can be drilled using the system.

In an embodiment, the collet includes a solid base as the physical stopping point for a drill bit inserted into the internal silo. Alternatively, the collet includes an indentation, rim, platform, bar, or the like as the physical stopping point for a drill bit inserted into the internal silo.

In an embodiment, the top of the collet includes a drill guide above the collar used to grip the drill bit inside the collet/bit assembly when installed in a drill. The drill guide acts as a visual aid to the user of a drill fitted with the collet/bit assembly to help the user visually gauge the angle of drilling and the maximum drilling depth.

In an embodiment, the collet is formed as a single piece. Alternatively, the collet includes two or more parts configured to provide the functionality of the collet, as described herein.

In an embodiment, the collet collar includes a plurality of slits, which is also referred to as kerf cuts, which assist in gripping the drill bit firmly inside the collet/bit assembly when the collet/bit assembly is installed in a drill. This arrangement is similar to standard collets used with handheld drills. Alternatively, the collet in this invention may include another collar gripping mechanism.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. For example, while most windshield repair technicians use a DREMEL® tool, the drill stop collet described herein can be used with any cordless or electric hand drill that has a chuck, e.g., DEWALT®, MILWAUKEE®, MAKITA®, and BOSCH®. That is both “cylindrical” (e.g., DREMEL®) and typical “pistol” shaped drills can be fitted with this invention. The internal silo can be shaped in a variety of ways such as with an octagonal cross section or a combination of cross sectional shapes (e.g., round at the top, square or trapezoidal at the bottom).

Accordingly, many different embodiments stem from the above description and the drawings. It will be understood that it would be unduly repetitious and obfuscating to literally describe and illustrate every combination and subcombination of these embodiments. As such, the present specification, including the drawings, shall be construed to constitute a complete written description of all combinations and sub combinations of the embodiments described herein, and of the manner and process of making and using them, and shall support claims to any such combination or subcombination.

In the specification, there have been disclosed embodiments of the invention and, although specific terms are employed, they are used in a generic and descriptive sense only and not for purposes of limitation. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. An apparatus for securely holding a drill bit for use with a handheld drill, the drill bit including a pointed end and a bottom end, the apparatus comprising:
a collet including
a silo for accommodating the drill bit therein, the silo including a fixed stop such that the bottom end of the drill bit rests against the fixed stop; and
a compressible collar for securing the drill bit within the silo when the apparatus is inserted into the handheld drill,
wherein the drill bit has a drill bit length and the silo has a silo depth shorter than the drill bit length such that, when the drill bit is inserted into the apparatus with the bottom end resting on the fixed stop, the pointed end of the drill bit protrudes from the apparatus by a maximum depth defined by the drill bit length minus the silo depth, and
wherein the apparatus, when used with the handheld drill, only allows drilling of holes having a depth up to the maximum depth.

2. The apparatus of claim 1, wherein the apparatus is configured for use in windshield repair, and the silo depth is configured such that the maximum depth is less than a thickness of an outer layer of a laminated automotive safety glass.

3. The apparatus of claim 1, wherein the compressible collar has a collar diameter, and the apparatus further comprising a drill guide having a drill guide diameter less than the collar diameter.

4. The apparatus of claim 1, wherein the fixed stop is formed of at least one of a solid base, a rim, an indentation, and a bar.

5. The apparatus of claim 1, wherein the silo and the compressible collar integrally formed in a single piece.

6. The apparatus of claim 1, wherein the silo and the compressible collar are separately formed, then assembled to form the apparatus.

7. The apparatus of claim 1, wherein the compressible collar includes at least one slit.

8. The apparatus of claim 1, wherein the compressible collar is formed of a compressible material.

9. An apparatus for securely holding a drill bit for use with a handheld drill, the drill bit including a pointed end and a bottom end, the apparatus comprising:
a collet including
a silo for accommodating the drill bit therein; and
a compressible collar for securing the drill bit within the silo when the apparatus is inserted into the handheld drill,
wherein the compressible collar has a collar diameter, and the apparatus further comprising a drill guide having a drill guide diameter less than the collar diameter such that, when the drill bit is inserted into the apparatus, a user is able to measure a protrusion distance by which the drill bit protrudes from the drill guide and the apparatus, when used with the handheld drill, only allows drilling of holes having a depth up to the protrusion distance.
